(19) United States
(12) Patent Application Publication
(10) Pub. No.: US 2014/0310534 A1
(43) Pub. Date: Oct. 16, 2014

(54) DATA SCRAMBLING IN MEMORY DEVICES USING COMBINED SEQUENCES

(71) Applicant: APPLE INC., Cupertino, CA (US)

(72) Inventors: Eyal Gurgi, Petah-Tikva (IL); Micha Anholt, Tel Aviv (IL); Shai Ojalvo, Moshav Olesh (IL)

(73) Assignee: Apple Inc., Cupertino, CA (US)

(21) Appl. No.: 13/862,549

(22) Filed: Apr. 15, 2013

(51) Int. Cl. G06F 12/14

(52) U.S. Cl. CPC G06F 12/1408
USPC 713/193

(57) ABSTRACT

A method for data storage includes generating a first scrambling sequence and a second scrambling sequence that is different from the first scrambling sequence. A combined sequence, which is equal to a bit-wise XOR between the first and second scrambling sequences, is generated. Data is copied from a first location in a memory in which the data is scrambled using the first scrambling sequence, to a second location in the memory in which the data is to be scrambled using the second scrambling sequence, by reading the data from the first location, scrambling the read data using the combined sequence, and then storing the data in the second location.

### FIELD OF THE INVENTION

The present invention relates generally to data storage, and particularly to methods and systems for data scrambling in memory devices.

### BACKGROUND OF THE INVENTION

Some memory systems scramble, or randomize, data before storing it in memory. For example, U.S. Patent Application Publication 2008/0215798, whose disclosure is incorporated herein by reference, describes randomization schemes in which original data to be stored in a non-volatile memory are first randomized while preserving the size of the original data. In response to a request for the original data, the randomized data are retrieved, de-randomized and exported without authenticating the requesting entity. ECC encoding is applied either before or after randomizing. Correspondingly, ECC decoding is applied either after or before de-randomizing.

U.S. Pat. No. 8,261,159, whose disclosure is incorporated herein by reference, describes a method for data storage that includes a set of scrambling sequences. Each data word is scrambled using a respective scrambling sequence selected from the set. The scrambled data words are stored in the memory device.

### SUMMARY OF THE INVENTION

An embodiment of the present invention provides a method for data storage, including defining a first scrambling sequence and a second scrambling sequence that is different from the first scrambling sequence. A combined sequence, which is equal to a bit-wise XOR between the first and second scrambling sequences, is generated. Data is copied from a first location in a memory, in which the data is scrambled using the first scrambling sequence, to a second location in the memory, in which the data is to be scrambled using the second scrambling sequence, by reading the data from the first location, scrambling the read data using the combined sequence, and then storing the data in the second location.

In some embodiments, the method further includes reading the data from the second location and de-scrambling the read data using the second scrambling sequence. In other embodiments, defining the first scrambling sequence includes defining a first seed which is used to generate the first scrambling sequence, defining the second scrambling sequence includes defining a second seed which is used to generate the second scrambling sequence, and generating the combined sequence includes calculating a combined seed by performing a bit-wise XOR between the first seed and the second seed, and generating the combined sequence using the combined seed.

In some other embodiments, generating the second seed includes initializing a Linear Feedback Shift Register (LFSR) to the first seed, and applying one or more clock cycles to the LFSR. In yet other embodiments, defining the first seed includes initializing the LFSR to the first seed, and defining the second seed includes multiplying the first seed in the LFSR by one or more powers of a predefined factor and applying zero or more clock cycles to the LFSR. In other embodiments, the method includes storing a set of the powers of the predefined factor in a memory, and multiplying the first seed includes retrieving one or more of the powers of the predefined factor from the memory, and multiplying the first seed by the retrieved powers.

In some embodiments the method includes storing a set of one or more combined sequences in a memory, and copying the data includes retrieving one of the combined sequences from the memory and scrambling the read data using the retrieved combined sequence. In some other embodiments, the first and second sequences correspond to the data stored in an entire memory unit, and the combined sequence defines copying of the data only from a portion of the memory unit.

There is also provided, in accordance with an embodiment that is described herein, an apparatus for data storage, including a memory and storage circuitry. The storage circuitry is configured to define a first scrambling sequence and a second scrambling sequence that is different from the first scrambling sequence, to generate a combined sequence, which is equal to a bit-wise XOR between the first and second scrambling sequences, and to copy data from a first location in the memory, in which the data is scrambled using the first scrambling sequence, to a second location in the memory, in which the data is to be scrambled using the second scrambling sequence, by reading the data from the first location, scrambling the read data using the combined sequence, and then store the data in the second location.

There is also provided, in accordance with an embodiment that is described herein, an apparatus for data storage including an interface for communicating with a memory, and storage circuitry. The storage circuitry is configured to define a first scrambling sequence and a second scrambling sequence that is different from the first scrambling sequence, to generate a combined sequence, which is equal to a bit-wise XOR between the first and second scrambling sequences, and to copy data from a first location in the memory, in which the data is scrambled using the first scrambling sequence, to a second location in the memory, in which the data is to be scrambled using the second scrambling sequence, by reading the data from the first location, scrambling the read data using the combined sequence, and then store the data in the second location.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a memory system, in accordance with an embodiment of the present invention;

FIG. 2 is a block diagram that schematically illustrates a scrambler/de-scrambler used in a memory system, in accordance with an embodiment of the present invention;

FIG. 3 is a diagram that schematically illustrates repeated copy and read operations of scrambled data, in accordance with embodiments of the present invention;

FIG. 4 is a flow chart that schematically illustrates methods for copying and reading scrambled data in a memory device, in accordance with an embodiment of the present invention;

FIG. 5 is a block diagram that schematically illustrates generation of a combined sequence by first combining two different seed values, in accordance with an embodiment of the present invention; and

FIG. 6 is a flow chart that schematically illustrates methods for copying scrambled data using combined seed values, in accordance with an embodiment of the present invention.

### DETAILED DESCRIPTION OF EMBODIMENTS

### Overview

Data storage systems sometimes scramble data before storing it in memory. Data scrambling (also referred to as data randomization) can be carried out, for example, by performing a bit-wise Exclusive Or (XOR) between the data and a pseudo-random scrambling sequence. Storage of scrambled data has a number of important advantages, such as elimination of severe and repetitive interference effects, and balancing of data-dependent cell wearing across the memory. Some signal processing schemes, such as adaptive estimation of read thresholds, perform better when operating on scrambled data.

It is sometimes necessary for a memory system or device to copy scrambled data from one memory location to another. For example, during the lifetime of the memory device, storage areas may become fragmented, i.e., the device may contain non-contiguous areas of valid data. Collecting fragments of valid data from different locations and grouping them to a continuous area at some other location (sometimes referred to as garbage collection or compaction) improves the utilization of the memory device. In many cases garbage collection serves as a maintenance procedure that may involve intensive copy operations.

A copy operation typically involves de-scrambling the data read from the first location using a first scrambling sequence, and then scrambling the data using a second scrambling sequence different from the first one, before storing to the new location. The coupled operation of de-scrambling followed by scrambling is also referred to as re-scrambling.

Embodiments of the present invention that are described hereinbelow provide improved methods and systems for data scrambling and de-scrambling in storage applications. The embodiments described herein refer mainly to data scrambling in solid-state memory devices, such as Flash devices, but the disclosed techniques are equally applicable to a wide variety of other storage devices and applications.

In some embodiments, data is copied from one location to another while applying only a single scrambling operation, which is derived from the scrambling and de-scrambling operations. The scrambled data read from the first location is re-scrambled using a combined sequence that is derived from the de-scrambling sequence (corresponding to the old memory location) and the scrambling sequence (corresponding to the new memory location). In other embodiments, scrambling seeds of the scrambling and de-scrambling sequences are combined to produce a combined seed, which is then initialized to a Linear Feedback Shift Register (LFSR) component to generate the combined sequence.

As opposed to copy operation using separate de-scrambling and then scrambling, the presented embodiments use only a single joint re-scrambling calculation that is equal in complexity to either scrambling or de-scrambling alone. By using joint re-scrambling, the copy operation becomes simpler to implement, runs faster, and consumes less power.

In some disclosed techniques, sequences or seeds to be combined are successively generated using LFSR. Given the LFSR is initiated to a first seed, the successive seed is generated by clocking the LFSR multiple times. Two scrambling sequences to be combined may be generated using the LFSR initialized to the first and successive seeds respectively.

Other disclosed methods use look-up tables to efficiently advance the LFSR state. In generating a successive seed, these methods achieve improved O(log(n)) and even O(1) complexity, as opposed to O(n) complexity achieved by clocking the LFSR n times.

Yet another disclosed method uses pairs of scrambling sequences comprising a scrambling sequence and a shifted version of that sequence. Paired sequences are XOR'ed to generate combined sequences that are stored in memory for later use. The disclosed method enables to significantly reduce the number of stored combined sequences. Moreover, the method defines an association between sequence pairs and corresponding offsets between memory locations, to improve the management of the memory.

The presented embodiments and techniques simplify software and/or hardware implementations for the copy of scrambled data, making the copy operations faster and more efficient in terms of power consumption.

### System Description

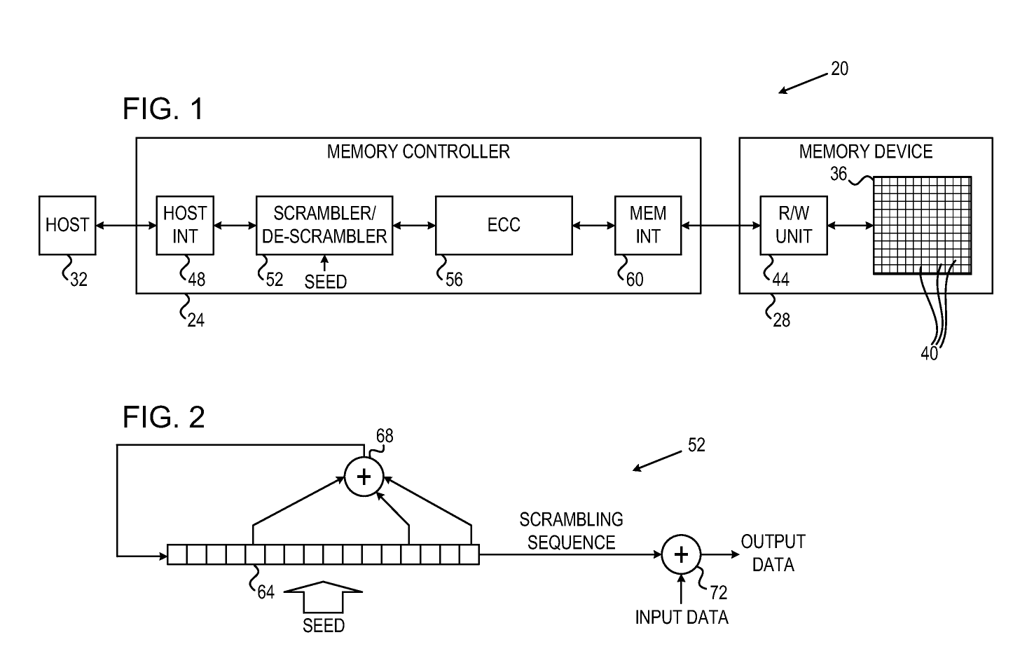

FIG. 1 is a block diagram that schematically illustrates a memory system 20, in accordance with an embodiment of the present invention. System 20 can be used in various host systems and devices, such as in computing devices, cellular phones or other communication terminals, removable memory modules, Solid State Disks (SSD), digital cameras, music and other media players and/or any other system or device in which data is stored and retrieved.

System 20 comprises a memory controller 24, which stores data in a memory device 28 and retrieves data stored in the memory device. Memory controller 24 communicates with a host 32, for accepting data for storage in the memory device and for outputting data retrieved from the memory device.

Memory device 28 stores the data received from the memory controller in a memory cell array 36. The memory array comprises multiple analog memory cells 40. In the context of the present patent application, the term “analog memory cell” is used to describe any memory cell that holds a continuous, analog value of a physical parameter, such as an electrical voltage or charge. Array 36 may comprise analog memory cells of any kind, such as, for example, NAND, NOR and Charge Trap Flash (CTF) Flash cells, phase change RAM (PRAM, also referred to as Phase Change Memory—PCM), Nitride Read Only Memory (NROM), Ferroelectric RAM (FRAM), magnetic RAM (MRAM) and/or Dynamic RAM (DRAM) cells.

The charge levels stored in the cells and/or the analog voltages or currents written into and read out of the cells are referred to herein collectively as analog values or storage values. Although the embodiments described herein mainly address threshold voltages, the methods and systems described herein may be used with any other suitable kind of storage values.

System 20 stores data in the analog memory cells by programming the cells to assume respective memory states, which are also referred to as programming levels. The programming levels are selected from a finite set of possible levels, and each level corresponds to a certain nominal storage value. For example, a 2 bit/cell MLC can be programmed to assume one of four possible programming levels by writing one of four possible nominal storage values into the cell.

Memory device 28 comprises a reading/writing (R/W) unit 44, which converts data for storage in the memory device to analog storage values and writes them into memory cells 40. In alternative embodiments, the R/W unit does not perform the conversion, but is provided with voltage samples, i.e., with the storage values for storage in the cells. When reading data out of array 36, R/W unit 44 converts the storage values of memory cells into digital samples having a resolution of one or more bits. Data is typically written to and read from the memory cells in groups that are referred to as pages. In some embodiments, the R/W unit can erase a group of cells 40 by applying one or more negative erasure pulses to the cells.

Memory controller 24 comprises a host interface 48 for communicating with host 32. The data accepted from the host is scrambled, or randomized, using a scrambling/de-scrambling unit 52 before it is sent to memory device 28 for storage. Data scrambling is desirable, for example, in order to avoid severe interference scenarios and to balance the wear of memory cells 40. Data retrieved from memory device 28 is de-scrambled by unit 52 before it is provided to the host. Data may be re-scrambled by unit 52 and stored in the memory as an internal copy operation without involving host 32. The operation of unit 52, as well as several techniques for copying and reading scrambled data, are described in detail below.

In some embodiments, memory controller 24 comprises an Error Correction Code (ECC) unit 56, which encodes the data for storage using a suitable ECC and decodes the ECC of data retrieved from the memory. Any suitable type of ECC, such as, for example, Low Density Parity Check (LDPC), Reed-Solomon (RS) or Bose-Chaudhuri-Hocquenghem (BCH), can be used. Memory controller 24 communicates with memory device 28 using a memory interface 60.

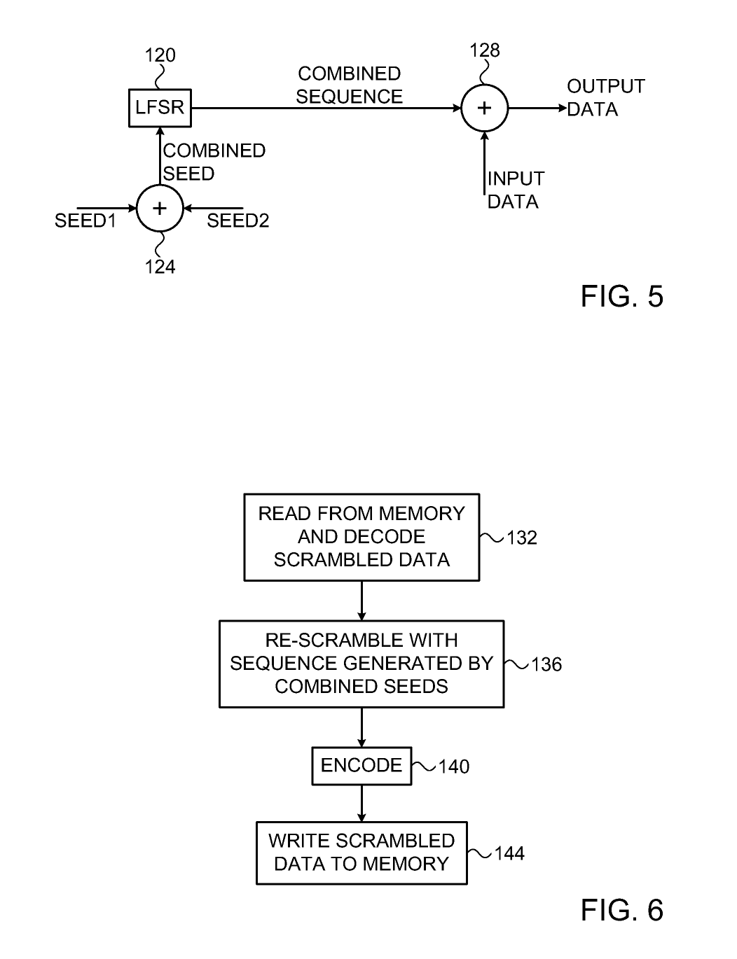

Some or all of the elements of memory controller 24, and in particular scrambling/de-scrambling unit 52, may be implemented in hardware. Example implementations of unit 52 are shown in FIG. 2 and FIG. 5 below. Alternatively, the memory controller may comprise a microprocessor that runs suitable software, or a combination of hardware and software elements.

The description that follows describes techniques for copying and reading of scrambled data. The disclosed techniques can be carried out by memory controller 24 and/or by R/W unit 44 and/or by host 32. For the sake of clarity, the description that follows refers to a particular division of functions between R/W unit 44 and memory controller 24. Generally, however, the various tasks making-up the disclosed techniques can be divided between the memory controller, the R/W unit and the host in any suitable manner, or performed by any one of these elements.

For example, the memory controller could provide the sequences and the R/W unit perform the XOR. Or, the memory controller could provide the seeds, and the R/W unit perform the XOR between them and generate the combined sequence. As another example, the host could provide the sequences and/or seeds, and either the memory controller or the R/W unit perform the XOR.

Thus, in the context of the present patent application and in the claims, memory controller 24, R/W circuitry 44 and possibly host 32 are referred to jointly as storage circuitry that carries out the disclosed techniques.

The configuration of FIG. 1 is an example system configuration, which is shown purely for the sake of conceptual clarity. Any other suitable memory system configuration can also be used. Elements that are not necessary for understanding the principles of the present invention, such as various interfaces, addressing circuits, timing and sequencing circuits and debugging circuits, have been omitted from the figure for clarity. Although FIG. 1 shows a single memory device 28 for the sake of clarity, in alternative embodiments a single memory controller may control multiple memory devices 28.

In the exemplary system configuration shown in FIG. 1, memory controller 24 and memory device 28 are implemented as two separate Integrated Circuits (ICs). In alternative embodiments, however, the memory device and the memory controller may be integrated on separate semiconductor dies in a single Multi-Chip Package (MCP) or System on Chip (SoC), and may be interconnected by an internal bus. Further alternatively, some or all of the memory controller circuitry may reside on the same die on which the memory array is disposed. Further alternatively, some or all of the functionality of memory controller 24 can be implemented in software and carried out by a processor or other element of the host system. In some embodiments, host 32 and memory controller 24 may be fabricated on the same die, or on separate dies in the same device package.

In some embodiments, memory controller 24 comprises a general-purpose processor, which is programmed in software to carry out the functions described herein. The software may be downloaded to the processor in electronic form, over a network, for example, or it may, alternatively or additionally, be provided and/or stored on tangible media, such as magnetic, optical, or electronic memory.

In an example configuration of array 36, memory cells 40 are arranged in multiple rows and columns, and each memory cell comprises a floating-gate transistor. The gates of the transistors in each row are connected by word lines, and the sources of the transistors in each column are connected by bit lines. The memory array is typically divided into multiple pages, i.e., groups of memory cells that are programmed and read simultaneously. Pages are sometimes sub-divided into sectors. In some embodiments, each page comprises an entire row of the array. In alternative embodiments, each row (word line) can be divided into two or more pages. For example, in some devices each row is divided into two pages, one comprising the odd-order cells and the other comprising the even-order cells. In a typical implementation, a two-bit-per-cell memory device may have four pages per row, a three-bit-per-cell memory device may have six pages per row, and a four-bit-per-cell memory device may have eight pages per row.

Erasing of cells is usually carried out in blocks that contain multiple pages. Typical memory devices may comprise several thousand erasure blocks. In a typical two-bit-per-cell MLC device, each erasure block is on the order of thirty-two word lines, each comprising several thousand cells. Each word line of such a device is often partitioned into four pages (odd/even order cells, least/most significant bit of the cells). Three-bit-per cell devices having thirty-two word lines per erasure block would have 192 pages per erasure block, and four-bit-per-cell devices would have 256 pages per block. Alternatively, other block sizes and configurations can also be used.

### Example Scrambler/De-Scrambler Structure

FIG. 2 is a block diagram that schematically illustrates scrambling/de-scrambling unit 52, in accordance with an embodiment of the present invention. Unit 52 scrambles data by producing a pseudo-random scrambling sequence, and calculating a bit-wise Exclusive Or (XOR) between the scrambling sequence and the data. De-scrambling is performed in a similar manner, i.e., by calculating bit-wise XOR between the scrambled data and the scrambling sequence, to reproduce the original data.

In the present example, unit 52 produces the scrambling sequence using a Linear Feedback Shift Register (LFSR). Unit 52 comprises an N-bit shift register 64. The content of shift register 64 is shifted one bit to the right in each clock cycle. A XOR gate 68 computes a XOR of a predefined subset of the shift register bits, and the XOR result is fed-back to the shift register input. The output of shift register 64 is used as a scrambling sequence. Given an appropriate selection of feedback taps (i.e., selection of shift register bits to be XOR'ed and fed-back to the input), the scrambling sequence has pseudo-random properties. In the example of FIG. 2, the LFSR processes a single bit per clock cycle. In other embodiments however, an LFSR may process and output multiple bits per clock cycle.

A XOR gate 72 calculates bit-wise XOR between an input data sequence and the scrambling sequence, to produce an output data sequence. When unit 52 performs scrambling, the input data comprises data accepted from the host, and the output data comprises scrambled data to be sent to the memory device. When unit 52 performs de-scrambling, the input data comprises scrambled data read from the memory device (possibly after error correction), and the output data comprises de-scrambled data to be sent to the host.

When unit 52 performs re-scrambling, the sequence generated by the LFSR comprises a combined sequence that performs the joint function of the scrambling and de-scrambling sequences, the input data comprises scrambled data that is read from a certain memory location, and the output data comprises data that is to be written in another memory location. In re-scrambling, the de-scrambled data is not sent to the host but is rather re-scrambled and sent back to the memory device.

When unit 52 initiates scrambling or de-scrambling certain data, the memory controller initializes shift register 64 to a certain N-bit initial value, referred to as a seed. The scrambling seed can be viewed as an initial offset along the scrambling sequence, from which the sequence generation begins. Therefore, setting an N-bit seed value can be viewed as selecting a scrambling sequence from a set of 2^{N} possible scrambling sequences. Several methods for generating and manipulating scrambling seeds and sequences are described below.

Typically, although not necessarily, a given scrambling sequence originating from a given seed is used for scrambling (or de-scrambling) a memory page. For example, a page having 34,368 bits can be scrambled by bit-wise XOR with a 34,368-bit scrambling sequence. In some embodiments, unit 52 supports a set of K<2^{N} possible seed values. Each seed value causes unit 52 to generate a respective pseudo-random scrambling sequence, which typically has small cross-correlation with the scrambling sequences of the other seed values. In an example embodiment, N=16 and K=127. Alternatively, any other suitable values can also be used.

The configuration of FIG. 2 is an example configuration, which is shown purely for the sake of conceptual clarity. In alternative embodiments, any other scrambler/de-scrambler configuration can also be used. For example, various other LFSR configurations are known in the art, and any such configuration can be used for generating scrambling sequences in unit 52. Further alternatively, the scrambling sequence can be generated in advance and stored in a memory, instead of generating it during scrambling or de-scrambling. An alternative scrambler scheme is described in FIG. 5 below.

In embodiments described herein, unit 52 is used for copying scrambled data from one memory location to another. Several methods for implementing efficient copy operations are described further below.

In the embodiments described herein, scrambling and de-scrambling are performed per memory page. In other words, unit 52 in memory controller 24 scrambles the data of a given memory page using a certain sequence or a seed, and stores the scrambled data in a certain memory page of device 28. When retrieving the memory page in question, unit 52 de-scrambles the data read from this memory page using the appropriate sequence or seed. Alternatively, however, scrambling and de-scrambling can be applied to any other suitable unit of data, such as to erasure blocks or sectors.

### Efficient Re-Scrambling Using Combined Sequences

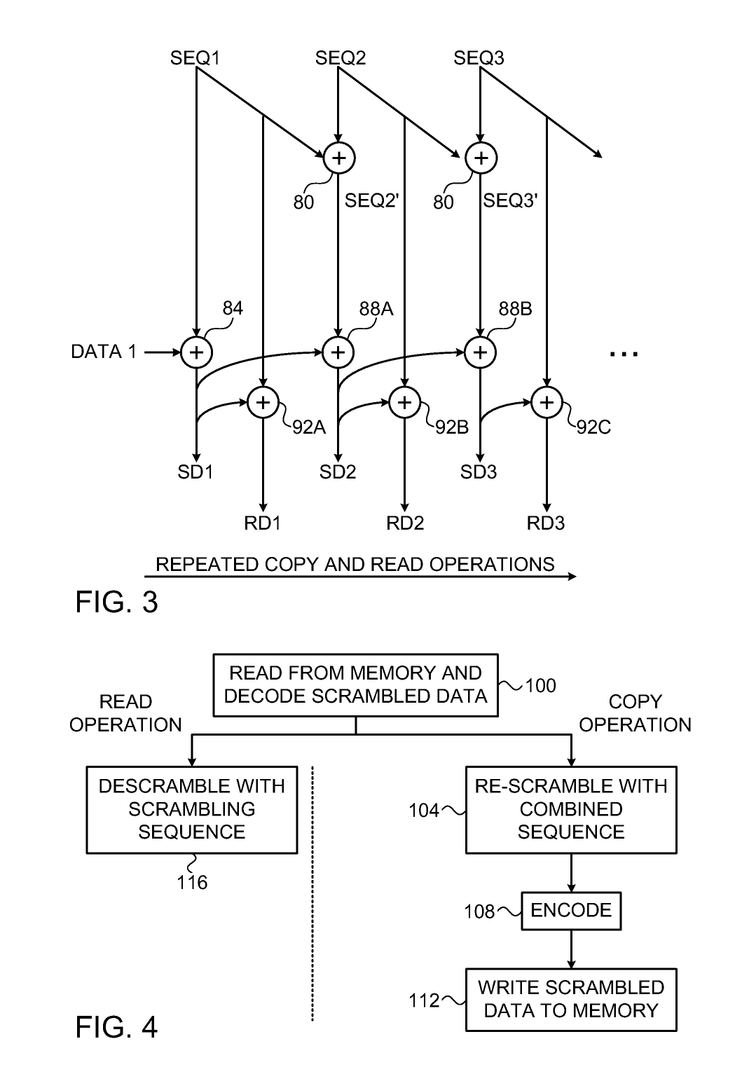

FIG. 3 is a diagram that schematically illustrates repeated copy and read operations of scrambled data, in accordance with embodiments of the present invention. Sequences SEQ1, SEQ2 and SEQ3 in the figure, denote scrambling sequences that can be generated for example using an LFSR. Sequences SEQ2′ and SEQ3′ in the figure denote combined sequences, derived by calculating bit-wise XOR between two scrambling sequences, e.g., SEQ2′=XOR(SEQ1, SEQ2). Since XOR is a linear operator, applying SEQ2′ to scrambled data is mathematically equivalent to de-scrambling the data with SEQ1 and then scrambling it with SEQ2.

In FIG. 3, components 80, 84, 88 and 92 represent XOR gates that are used for scrambling and de-scrambling. Each XOR gate 80 accepts two scrambling sequences at the input and calculates a combined sequence. XOR gate 84 accepts data to be initially stored and a scrambling sequence, and calculates scrambled data SD1. SD1 is written to the memory device at a first memory location. XOR gates 88 accept at the input scrambled data read out of the memory and a combined sequence, and calculate re-scrambled data (e.g., SD2 and SD3). XOR gates 92 accept scrambled data read out of the memory and a scrambling sequence, to reproduce the original data at the gate output.

In FIG. 3, DATA1 represents a certain data page to be initially stored in the memory device. SD1, SD2 and SD3 represent different scrambled versions of DATA1 stored in the memory. More specifically, SD1 represents the initially-stored data page, and SD2 and SD3 represent re-scrambled versions of DATA1 related to copy operations. Outputs RD1, RD2 and RD3 of gates 92 in the figure, denote de-scrambled data generated when the original data is retrieved out of the memory. In other words, RD1, RD2 and RD3 should equal DATA1.

When initially stored, DATA1 is scrambled using gate 84 by calculating SD1=XOR(DATA1, SEQ1). Scrambled data SD1 is then written to a first memory location. To retrieve the original data, SD1 is read out of the first memory location and de-scrambled using gate 92A by calculating RD1=XOR(SD1, SEQ1).

To copy SD1 to a second location, SD1 is read out of the first memory location and re-scrambled using gate 88A by calculating SD2=XOR(SD1, SEQ2′). SD2 is then written to a second memory location. By using explicit expressions for SD1 and SEQ2′ an equivalent expression for SD2, i.e., SD2=XOR(DATA1, SEQ2) may be derived. Therefore, to retrieve the original data out of the second memory location, gate 92B calculates RD2=XOR(SD2, SEQ2) as depicted in the figure.

To further copy SD2 to a third memory location, SD2 is read out of the second memory location and is input to gate 88B that calculates SD3=XOR(SD2, SEQ3′). SD3 is stored to the third memory location. It should be appreciated that as the combined sequences are prepared beforehand, a copy operation involves only a single XOR operation using gates 88. Typically following a copy operation, multiple read operations may be performed to retrieve the original data. Note that in FIG. 3, multiple gates for repeated operations are purely shown for the sake of clarification. Embodiments described herein below, typically use one gate of each group.

### Repeated Copy Operations of Scrambled Data

FIG. 4 is a flow chart that schematically illustrates methods for copying and reading of scrambled data in a memory device, in accordance with an embodiment of the present invention. FIG. 4 describes a method for a copy operation and a method for a read operation, both methods begin at a read and decode step 100. At step 100, memory controller 24 reads a scrambled and ECC-encoded data page from a first memory location in memory device 28. The memory controller then applies ECC decoding to the read data using ECC unit 56.

In case the memory controller performs a copy operation (e.g., as part of a garbage collection operation), the controller proceeds to a re-scramble step 104. At step 104 the memory controller uses scrambler/de-scrambler unit 52 to re-scramble the decoded data using a combined sequence. The memory controller then encodes the re-scrambled data, at an encoding step 108, using ECC unit 56. In some embodiments, the memory controller may store the re-scrambled data without ECC encoding. The copy operation method terminates by the memory controller sending the encoded data for storage in memory device 28, at a storage step 112. The re-scrambled data is then stored to a different memory location.

In case the memory controller performs a read operation following step 100 above, the memory controller proceeds to a de-scramble step 116. Memory controller 24 de-scrambles the read data using unit 52. The read operation method terminates by memory controller sending the retrieved data to host 32 via host interface 48.

The methods described in FIG. 4 can generate scrambling and combined sequences using any suitable method. Methods for generating combined and scrambling sequences are described further below.

### Memory Management Using Combined Sequences

Some disclosed embodiments use pre-computed and stored combined sequences. Since there are up to 2^{N} possible scrambling sequences for an N-bit seed, storing all possible combinations of combined sequences is typically not feasible. In one embodiment the memory controller stores only a subset of combined sequences. The memory controller may select any suitable subset of combined sequences.

As an example, the memory controller may generate combined sequences by XOR'ing a scrambling sequence with an n-shifted version of that scrambling sequence. For sequences of L-bits length, the n-shifted sequence may be generated by clocking the LFSR n more times following the generation of the first sequence, and taking the last L generated bits. Alternatively, if a scrambling sequence originates from a given seed, then the n-shifted sequence is originated from a seed that is generated from the former given seed by clocking the LFSR n times. The memory controller may use any suitable number of shifts, such as n=3, for the n-shifted sequence. When the shift number n is constant, all the sequences and pairs may be calculated starting with a given sequence, and repeatedly shifting that sequence n steps in each iteration to generate subsequent sequences.

To manage copy operations using a partial subset of combined sequences, the memory controller may regard a scrambling sequence and its associated n-shifted sequence as a sequence pair. Additionally or alternatively, the memory controller may restrict the destination memory location in copy operations. For example the destination memory location in a copy operation may reside at an offset from the source location, wherein the offset is associated with the number of shifts in the n-shifted sequence. By associating an offset between memory locations and the sequence pair, the memory controller can manage the storage space more efficiently e.g., in garbage collection.

### Scrambling Using Combined Seed Values

FIG. 5 is a block diagram that schematically illustrates generation of a combined sequence by first combining two different seed values, in accordance with an embodiment of the present invention. The embodiment in FIG. 5 may be considered as an alternative embodiment to scrambler unit 52 described in FIG. 2.

The embodiment of FIG. 5 uses the fact that the various operations performed by the LFSR and the XOR gates are linear. Since LFSR and XOR are all linear operations, XOR'ing the two seeds and then generating a sequence using the combined seed is equivalent to generating a sequence from each seed and then XOR'ing the sequences. In addition, seed sequences are typically much shorter than scrambling sequences, and therefore require simpler XOR gates to calculate the bit-wise XOR.

In FIG. 5, memory controller 24 uses LFSR 120 to generate combined sequences. A XOR gate 124 calculates bit-wise XOR between two seed values denoted by SEED1 and SEED2, to produce a combined seed. In one embodiment, the combined seed is generated in real-time during the re-scrambling operation. In an alternative embodiment, the combined seed is calculated beforehand.

The output of XOR gate 124 (the combined seed) is used for initializing LFSR 120. The LFSR generates an output scrambling sequence referred to as a combined sequence. XOR gate 128 scrambles an input data by calculating bit-wise XOR with the combined sequence, to produce output data (a re-scrambled sequence). In one embodiment, the memory controller may configure the LFSR to be initialized with SEED1 and not with the combined seed. In this case, the embodiment of FIG. 5 reduces to the scrambler/de-scrambler embodiment described in FIG. 2.

The memory controller may use any suitable method for generating scrambling seeds and/or combined seeds. Efficient methods for generating scrambling seeds are described further below.

FIG. 6 is a flow chart that schematically illustrates a method for copying scrambled data using combined seed values, in accordance with an embodiment of the present invention. The method begins at a read and decode step 132. Memory controller 24 reads scrambled data out of the memory and decodes the data, similarly to the description at step 100 above.

The memory controller then re-scrambles the data at a re-scramble step 136. The memory controller first combines two different seeds using XOR gate 124 to calculate a combined seed as shown in FIG. 5 above. LFSR 120 is initialized with the combined seed, and the memory controller then generates a combined sequence. The combined sequence is XOR'ed with the input data using XOR gate 128 to produce the re-scrambled data. The memory controller then encodes the re-scrambled data with ECC, at an encode step 140, and writes the data to the memory device at a write to memory step 144. Steps 140 and 144 are similar to steps 108 and 112 described in FIG. 4 above.

### Efficient Generation of Scrambling Seeds

In the embodiments described above, memory controller may use any suitable method for generating scrambling seeds or sequences. In one embodiment, for an LFSR comprising an N-bit shift register, up to 2^{N} seeds/sequences or combined seeds/sequences can be pre-stored prior to copy operations. Scrambling seeds and sequences can be generated and/or stored by memory controller 24, by memory device 28, or by host 32. Seeds/sequences generated and/or stored outside the memory controller may be sent to the memory controller over a respective interface.

In some embodiments, seeds can be generated using LFSR. In this case, the LFSR is set to some initial seed, and each successive seed is generated by applying a certain number of clocks to the LFSR. The memory controller may use any initial seed and any number of clocks to apply to generate each successive seed. The complexity of generating a seed by applying n clock cycles, is on the order of O(n).

The bit-content combinations in the LFSR can be mathematically interpreted as elements of a Galois field or other finite field. The bit-content of the LFSR shift register is referred to herein as an LFSR state. Initializing the LFSR to a certain seed is equivalent to initializing the LFSR state to the seed value. Each applied clock to the LFSR transfers it to a successive state.

Mathematically, clocking the LFSR once is equivalent to multiplying a polynomial represented by the state's bits by a primitive element of the finite field referred to as α. α is typically related to and determined by the feedback structure of the LFSR. Thus, applying n clock cycles to the LFSR is equivalent to a multiplication of the seed or state by αⁿ. The primitive element α is also referred to as a “predefined factor”.

In some embodiments, the memory controller performs multiple read operations (successively) to retrieve data stored at random locations in the memory. Access to random locations may occur, for example, in garbage collection. Each random read involves de-scrambling the read data with a respective seed. It is possible in principle to generate each seed from the initial seed by clocking the LFSR multiple times, but this solution is very costly in terms of latency and power consumption.

Alternatively, in one embodiment, memory controller 24 stores a seed along with multiple powers of α. Powers of α may be efficiently calculated using a suitable exponentiation circuit or any other suitable means. When the multiplication of the seed by some power of α directly gives a successive seed, the related complexity is on the order of O(1).

Other embodiments may trade-off differently the memory size versus calculation speed. For example, in an embodiment, the memory controller can calculate and store multiplication of only a partial subset of the powers of α. As an example, by multiplying a seed by α, α², α⁴, α⁸, α¹⁶ . . . , a complexity of O(log(n)) may be achieved. As an example for n=30, the memory controller can multiply the seed by α¹⁶, then by α⁸, and finally apply six clock cycles to the LFSR. Other embodiments may use any other suitable partial set of powers of α. In yet other embodiments, some or all of the powers of a may be calculated on the fly instead of pre-calculated and stored.

In some embodiments, the linear operation of the LFSR may be extended to a more general linear operation, i.e., a matrix multiplication. Thus, the basic shift operation is replaced with a multiplication of the state by a suitable state-transition matrix, and multiple LFSR shifts are replaced with a multiplication by a respective power of that matrix. By storing a selected subset of powers of the transition-state matrix (similarly to storing a subset of the powers of a as described above), a complexity of O(log(n)) may be achieved.

The techniques described above for efficient advancing the LFSR state may be useful in other embodiments as described below. Consider for example, a scrambled data stored in the memory device in some memory unit such as a memory page, block, or any other suitable unit. In the present example, the memory controller needs to access a portion of the stored data. Before storing, the data portion was XOR'ed with a corresponding portion of a scrambling sequence, starting at some mid-point of the sequence. In order to retrieve the data portion, the memory controller should first advance the LFSR to the state that starts the mid-sequence. Moreover, when re-scrambling using combined sequences, the controller should generate the combined sequence starting at the respective mid-point. The described above techniques enable to advance the LFSR to the correct starting state with a complexity of O(log(n)).

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for data storage, comprising:
defining a first scrambling sequence and a second scrambling sequence that is different from the first scrambling sequence;
generating a combined sequence, which is equal to a bit-wise XOR between the first and second scrambling sequences; and
copying data from a first location in a memory, in which the data is scrambled using the first scrambling sequence, to a second location in the memory, in which the data is to be scrambled using the second scrambling sequence, by reading the data from the first location, scrambling the read data using the combined sequence, and then storing the data in the second location.

2. The method according to claim 1, and comprising reading the data from the second location and de-scrambling the read data using the second scrambling sequence.

3. The method according to claim 1, wherein defining the first scrambling sequence comprises defining a first seed which is used to generate the first scrambling sequence, wherein defining the second scrambling sequence comprises defining a second seed which is used to generate the second scrambling sequence, and wherein generating the combined sequence comprises calculating a combined seed by performing a bit-wise XOR between the first seed and the second seed, and generating the combined sequence using the combined seed.

4. The method according to claim 3, wherein generating the second seed comprises initializing a Linear Feedback Shift Register (LFSR) to the first seed, and applying one or more clock cycles to the LFSR.

5. The method according to claim 3, wherein defining the first seed comprises initializing the LFSR to the first seed, and wherein defining the second seed comprises multiplying the first seed in the LFSR by one or more powers of a predefined factor, and applying zero or more clock cycles to the LFSR.

6. The method according to claim 5, and comprising storing a set of the powers of the predefined factor in a memory, wherein multiplying the first seed comprises retrieving one or more of the powers of the predefined factor from the memory, and multiplying the first seed by the retrieved powers.

7. The method according to claim 1, and comprising storing a set of one or more combined sequences in a memory, wherein copying the data comprises retrieving one of the combined sequences from the memory and scrambling the read data using the retrieved combined sequence.

8. The method according to claim 1, wherein the first and second sequences correspond to the data stored in an entire memory unit, and wherein the combined sequence defines copying of the data only from a portion of the memory unit.

9. Apparatus for data storage, comprising:
a memory; and
storage circuitry, which is configured to define a first scrambling sequence and a second scrambling sequence that is different from the first scrambling sequence, to generate a combined sequence, which is equal to a bit-wise XOR between the first and second scrambling sequences, and to copy data from a first location in the memory, in which the data is scrambled using the first scrambling sequence, to a second location in the memory, in which the data is to be scrambled using the second scrambling sequence, by reading the data from the first location, scrambling the read data using the combined sequence, and then store the data in the second location.

10. The apparatus according to claim 9, wherein the storage circuitry is configured to read the data from the second location and to de-scramble the read data using the second scrambling sequence.

11. The apparatus according to claim 9, wherein the storage circuitry is configured to define a first seed which is used to generate the first scrambling sequence, to define a second seed which is used to generate the second scrambling sequence, to calculate a combined seed by performing a bit-wise XOR between the first seed and the second seed, and to generate the combined sequence using the combined seed.

12. The apparatus according to claim 11, wherein the storage circuitry is configured to generate the second seed by initializing a Linear Feedback Shift Register (LFSR) to the first seed, and to apply one or more clock cycles to the LFSR.

13. The apparatus according to claim 11, wherein the storage circuitry is configured to initialize the LFSR to the first seed, and to define the second seed by multiplying the first seed in the LFSR by one or more powers of a predefined factor and then applying zero or more clock cycles to the LFSR.

14. The apparatus according to claim 13, wherein the storage circuitry is configured to store a set of the powers of the predefined factor in a memory, and to multiply the first seed by retrieving one or more of the powers of the predefined factor from the memory and multiplying the first seed by the retrieved powers.

15. The apparatus according to claim 9, wherein the storage circuitry is configured to store a set of one or more combined sequences in a memory, and to copy the data by retrieving one of the combined sequences from the memory and scrambling the read data using the retrieved combined sequence.

16. The apparatus according to claim 9, wherein the first and second sequences correspond to the data stored in an entire memory unit, and wherein the combined sequence defines copying of the data only from a portion of the memory unit.

17. Apparatus for data storage, comprising:
an interface for communicating with a memory; and
storage circuitry, which is configured to define a first scrambling sequence and a second scrambling sequence that is different from the first scrambling sequence, to generate a combined sequence, which is equal to a bit-wise XOR between the first and second scrambling sequences, and to copy data from a first location in the memory, in which the data is scrambled using the first scrambling sequence, to a second location in the memory, in which the data is to be scrambled using the second scrambling sequence, by reading the data from the first location, scrambling the read data using the combined sequence, and then store the data in the second location.

18. The apparatus according to claim 17, wherein the storage circuitry is configured to define a first seed which is used to generate the first scrambling sequence, to define a second seed which is used to generate the second scrambling sequence, to calculate a combined seed by performing a bit-wise XOR between the first seed and the second seed, and to generate the combined sequence using the combined seed.

19. The apparatus according to claim 17, wherein the storage circuitry is configured to initialize the LFSR to the first seed, and to define the second seed by multiplying the first seed in the LFSR by one or more powers of a predefined factor and then applying zero or more clock cycles to the LFSR.

20. The apparatus according to claim 17, wherein the first and second sequences correspond to the data stored in an entire memory unit, and wherein the combined sequence defines copying of the data only from a portion of the memory unit.
